(19) United States
(12) Patent Application Publication
(10) Pub. No.: US 2009/0154056 A1
(43) Pub. Date: Jun. 18, 2009

(54) Low inductance capacitor and method of manufacturing same

(75) Inventors: Eladio Clemente Delgado, Burnt Hills, NY (US); Michael Andrew de Rooij, Schenectady, NY (US); Patricia Chapman Irwin, Altamont, NY (US); Yang Cao, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/002,616

(22) Filed: Dec. 17, 2007

(51) Int. Cl. H01G 4/012; H01G 7/00

(52) U.S. Cl. 361/304; 29/25.42

(57) ABSTRACT

A film capacitor includes metallization that is sectionalized, patterned and configured to provide interconnections on only one face of a rolled or stacked film capacitor.

### BACKGROUND

The invention relates generally to capacitors, and more particularly to a low inductance capacitor structure and a method of manufacturing same.

Film capacitors generally employ electrode terminations on opposite sides of the capacitor housing/structure. This structure exhibits high inductance and resistance which can reduce the effectiveness of the capacitance, especially when used in power electronic circuits where the unwanted inductance can generate voltage overshoots and electrical noise. Requirements for new power electronic designs having much higher switching frequencies of semiconductors demand very tight interconnections to bus bars and/or capacitors. New requirements also demand that capacitors operate at much higher ripple current frequencies and carry higher currents.

The foregoing challenges translate into the need for improved electrical performance over traditional capacitors to provide lower equivalent series inductance (ESL) and equivalent series resistance (ESR). A high ESR can increase the self heating of the capacitor(s) and reduce its working life expectancy. A high ESL can reduce the capacitor's self resonant frequency and produce ringing associated with rapid current changes.

Although much work has been done to improve the dielectrics for capacitors, packaging designs have been lagging where improving the ESR and ESL of the capacitor by other means can yield significantly better results than improvements in the dielectrics and conductors of the capacitor can.

Connections in many existing cylindrical capacitors with terminations on the same side of the package are accomplished by soldering a strap on the opposite side terminal and bringing a conductive strap around the capacitor package to form connections on the same side of the capacitor. This technique makes the capacitor appear to have the terminations on the same side, but electrically, the connection that is brought around the package forms an interconnecting loop adding inductance to the overall capacitor to system interconnection. Further, in present capacitors, each electrode metallization is continuous; thus eddy currents can build in the capacitor due to magnetic flux induced by the capacitor's high frequency internal current, producing self-heating affects and increasing the overall ESR.

Recently, external loops placed in proximity to the capacitor and that produce a magnetic field have been proposed with some success. This concept however, is limited as the coupling between the external loop and the capacitor ESL is limited, thus limiting its effectiveness.

In view of the above, a need therefore exists for a capacitor structure having the interconnections on the same side of the capacitor while simultaneously achieving very low interconnecting inductance, reduced self-heating, a wider frequency response and a lower ESR, when compared to known capacitor structures.

### BRIEF DESCRIPTION

According to one aspect of the invention, a film capacitor comprises metallization that is sectionalized, patterned and configured to provide interconnections on only one edge of a rolled or stacked film capacitor.

According to another aspect, a method of making a film capacitor comprises:
patterning a first metalized film electrode group and a second metalized film electrode group to form a common dielectric structure; and
rolling the common dielectric structure such that together the first metalized film electrode group and the second metalized film electrode group form a sectioned and patterned metalized film capacitor having interconnections on only one face of a circular end of the capacitor.

According to yet another aspect, a method of making a film capacitor comprises:
patterning a first metalized film electrode group and a second metalized film electrode group to form a common dielectric structure;
rolling the common dielectric structure such that together the first metalized film electrode group and the second metalized film electrode group form a roll of sectioned and patterned metalized film;
slicing a desired number of sections from the roll of sectioned and patterned metalized film; and
stacking the desired number of sections together to form a stacked metalized film capacitor having interconnections on only one edge of the stack.

According to still another aspect, a method of making a film capacitor comprises:
patterning at least one first metalized film electrode;
patterning at least one second metalized film electrode; and
stacking the at least one first metalized film electrode and the at least one second metalized film electrode such that together the at least one first metalized film electrode and the at least one second metalized film electrode form a stacked metalized film capacitor having interconnections on only one edge of the stack.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a top view of a top side of a first electrode group and a top view of a bottom side of a second electrode group, together forming a composite structure suitable for rolling together to form a cylindrical capacitor according to one aspect of the invention;

FIG. 2 is a pictorial diagram illustrating a cylindrical capacitor structure using the first and second electrode groups depicted in FIG. 1;

FIG. 3 is a pictorial view illustrating the cylindrical capacitor depicted in FIG. 2 having metal termination tabs;

FIG. 4 is a pictorial view illustrating the cylindrical capacitor depicted in FIG. 2 having threaded male or female termination studs;

FIG. 5 illustrates wide loop current path associated with a cylindrical capacitor having an interconnection technology known in the art;

FIG. 6 is a side view of the cylindrical capacitor shown in FIG. 5 illustrating the current paths in the capacitor plates for the cylindrical capacitor;

FIG. 7 illustrates a reduced loop current path associated with a cylindrical capacitor having a sectionalized and patterned interconnection technology according to one aspect of the invention;

FIG. 8 is a side view of the cylindrical capacitor shown in FIG. 7 illustrating the current paths in the capacitor plates for the cylindrical capacitor;

FIG. 9 illustrates a cylindrical capacitor known in the art;

FIG. 10 is a cross sectional view showing one portion of the cylindrical capacitor depicted in FIG. 9;

FIG. 11 is a pictorial diagram illustrating a cylindrical capacitor structure according to another aspect of the invention;

FIG. 12 is a cross sectional view showing one portion of the cylindrical capacitor depicted in FIG. 11;

FIG. 13 is a cross sectional view showing another portion of the cylindrical capacitor depicted in FIG. 11;

FIG. 14 shows a pair of cookie-cut electrode groups suitable to form a stacked metalized film capacitor;

FIG. 15 shows a stacked capacitor structure implemented using a plurality of cookie-cut electrode groups depicted in FIG. 14;

FIG. 16 shows the stacked capacitor structure depicted in FIG. 15 with connecting studs to form a completed stacked capacitor;

FIG. 17 shows the completed stacked capacitor shown in FIG. 16 connected to DC bus bars with laminar interconnecting structures;

FIG. 18 is a side view of the completed stacked capacitor shown in FIGS. 16-17 illustrating the current flow paths in the plates of the completed stacked capacitor to create flux cancelling effects; and

FIG. 19 illustrates a plurality of high temperature, high performance cylindrical capacitors configured for use within a high power density, high power inverter suitable for high end power conversion applications such as, without limitation, avionics applications, according to one aspect of the invention.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

The electrical parameters of a real capacitor deviate from the ideal due to the structure and materials that make up the capacitor and that adds parasitic elements which can adversely impact its performance. Ways are described herein below to improve the packaging of a traditional film capacitor to reduce the electrical values of the parasitic elements and thereby improve the performance of the capacitor.

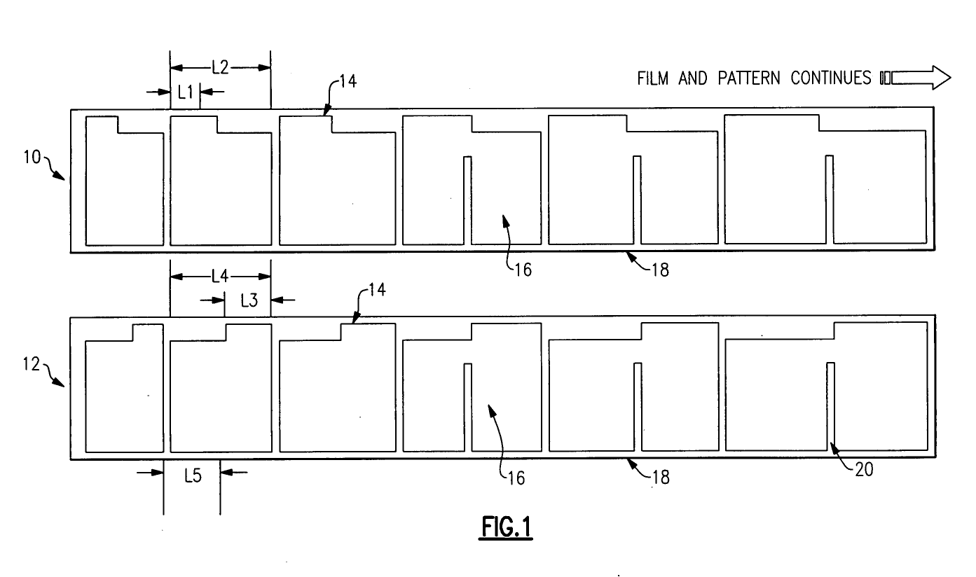

FIGS. 1-4 and 7-8 referenced below are directed to aspects of the invention that reduce interconnecting inductance by sectioning and patterning of capacitor metallization in such a way so as to provide interconnections on only one side and half of a rolled or stacked film capacitor, when viewed in the direction of a winding axis.

Looking now at FIG. 1, a first electrode group 10 and a second electrode group 12 suitable for rolling together to form a cylindrical capacitor are shown according to one aspect of the invention. First and second electrodes groups 10, 12 include connecting features 14 and sectioned and patterned metal depositions 16 on a film 18 that is also implemented to form sub partitions 20. According to one aspect, the number of sub partitions 20 increases as the partitions get larger. The dimensions L1-L5 are mathematically calculated for proper placement when the first and second electrode groups 10, 12 are rolled to form a metalized film capacitor such as described herein below with reference to FIGS. 2-4.

The metal patterning configuration is also designed to cancel magnetic fields created by the current flow within the capacitor by applying flux-canceling techniques described in further detail below with reference to FIGS. 5-8. The metal patterning allows for the capacitor to have both electrodes on the same axial side of the structure, and further ensures a very tight interconnection to a system to which the capacitor is attached. A reduction in parasitic inductance is achieved by patterning the film metallization during manufacturing. The metallization pattern is designed in such a manner that as the film is stacked or rolled, the metal pattern creates two distinct interconnections.

FIG. 2 is a pictorial diagram illustrating a cylindrical capacitor structure 30 using the first and second electrode groups 10, 12 depicted in FIG. 1. One metalized interconnecting feature 14 is created for each electrode of the capacitor 30 on the half side of the capacitor designated for that connection, and is repeated on the other half of the other connection. This creates a structure with two electrodes on the same axial side of the capacitor structure 30. In the case of a cylindrical capacitor 30, the interconnections 10, 12 form half circles with sufficient voltage breakdown clearance between the two halves.

Interconnecting features 14 can be constructed, for example by spray attaching a plurality of terminal conductors to the rolled or stacked film capacitor 30. According to one embodiment, interconnecting features 14 are constructed by first filling in recessed areas of the rolled or stacked film capacitor 30 at least partially with a low viscosity filler material, and then spraying at least one portion of the filled areas to provide at least one metalized contact area.

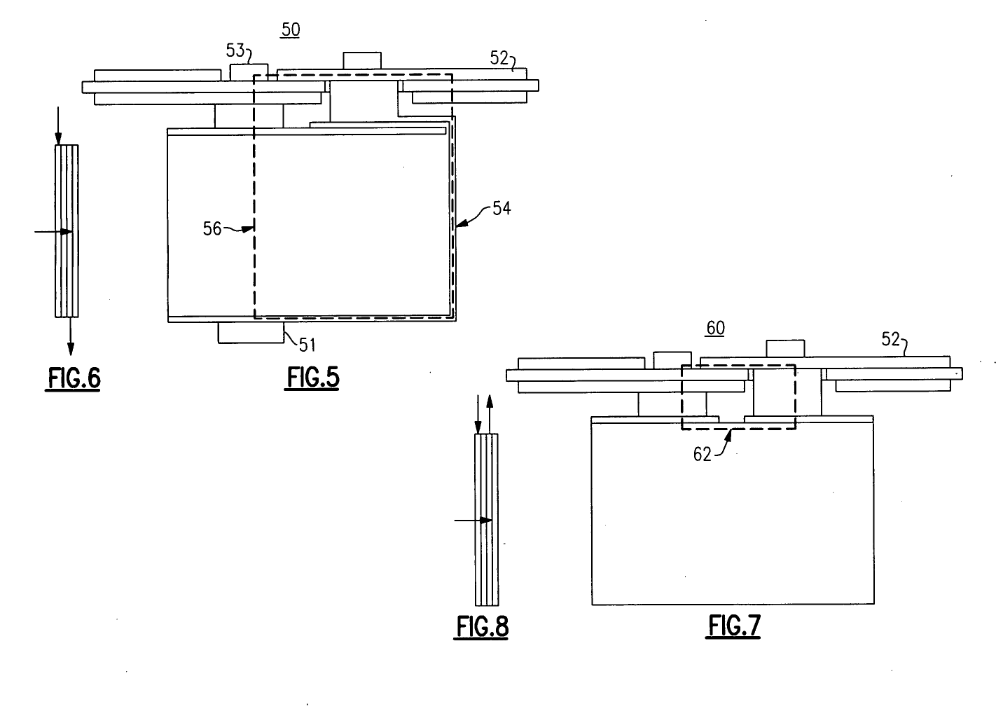

Further, sectioning the metallization patterns 16 minimizes eddy currents which are produced by directional current flow on the capacitor plates such as described below with reference to FIGS. 6 and 8. This concept extends to the form factor of the capacitor 30 so as to minimize current density and produce a capacitor with lower equivalent series resistance. According to one aspect, the form factor for the capacitor 30 is a short and flat cylinder 32 with a wide diameter 34. This increases the contact area of each interconnection 14 and reduces the current density of the plates by making the patterned plates wider with short lengths along the current carrying path and further decreases the capacitors ESR and ESL.

The foregoing concepts can just as easily be applied to both rolled and stacked film capacitor structures. In the case of the stacked film capacitor, the patterned metalized film is cookie-cut from the roll and then stacked to produce a multilayer film capacitor. The pattern is designed in such a way so that on one electrode, the pattern will have a tab on one side of the termination end, while the opposing electrode will have its tab on the opposite side of the termination end. The overhanging tabs will be folded and then metalized to form the capacitor interconnections, which are located on the same side of the capacitor. Again, the form factor according to one aspect is short and wide.

FIG. 3 is a pictorial view illustrating the cylindrical capacitor 30 depicted in FIG. 2 having metal termination tabs to form a completed capacitor 40. The metal tabs include mounting holes 42 for attaching the capacitor 40 to a desired assembly.

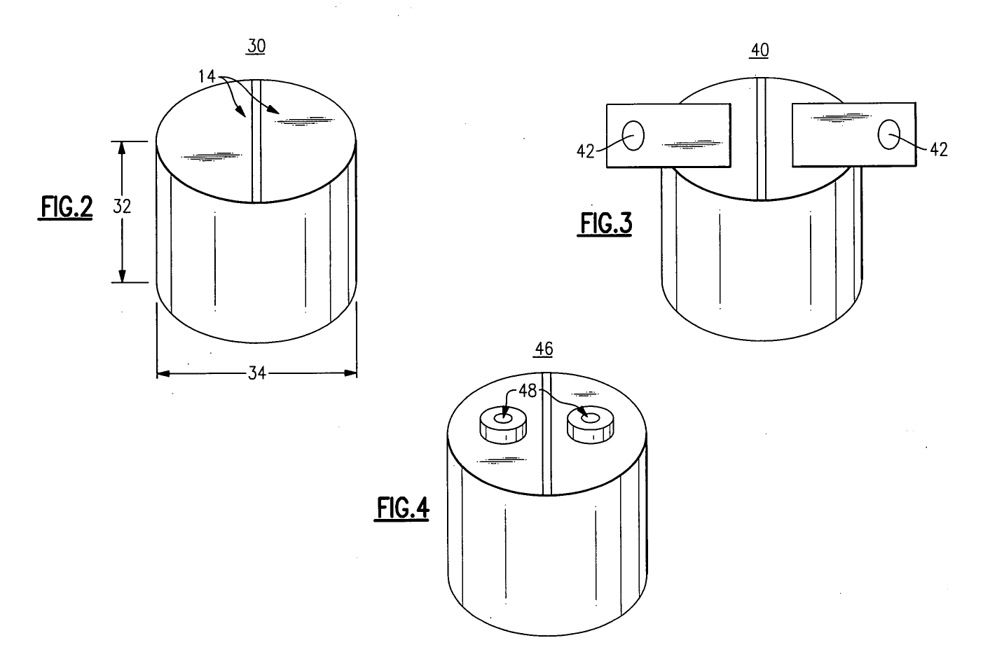

FIG. 4 is a pictorial view illustrating the cylindrical capacitor 30 depicted in FIG. 2 having threaded male or female termination studs 48 to form a completed capacitor 46 according to another embodiment. The termination studs 48 provide a means for attaching, without limitation, electrical wires, crimp terminals, or stacked planar low inductance interconnections, and the like to the completed capacitor 46.

One process employed to produce the capacitor as depicted in FIGS. 1-4 thus adds a mask to a rolled film process to produce the sectionalized pattern. The mask could be applied to the film and then removed after the metal has been applied; or the mask can be a contiguous roll having the desired mask pattern rolled along with the capacitor film past the stationary metal spraying head, thus producing the desired metal pattern on the capacitor film.

The mask pattern roll in one aspect has a repeating pattern which passes by the metal spraying head in a contiguous loop. This process advantageously requires minimal upgrades or modifications to many existing metallization chambers. The repeating pattern will generally change with the rolling radius.

Moving now to FIG. 5, a cylindrical capacitor interconnection structure 50 is illustrated with known interconnection technology. Known film capacitor structures generally employ electrode terminations 51, 53 on opposite sides of the capacitor housing/structure such as shown in FIG. 5. This well known structure exhibits undesirably high inductance and resistance, which can reduce the effectiveness of the capacitance, especially when used in power electronic circuits where the unwanted inductance can generate voltage overshoots and hence electrical noise and induced capacitor stress.

Requirements for new power electronic designs having much higher switching frequencies of semiconductors demand very tight interconnections to bus bars and/or capacitors. The new requirements also demand capacitors to operate at much higher ripple current frequencies and carry higher currents. This translates into the need for improved electrical performance over traditional capacitors that do not exhibit the requisite lower ESL and ESR necessary to meet the demands of the foregoing new requirements.

A high ESR can increase the self heating of a capacitor and reduce its working life expectancy. Much work has been done to improve the dielectrics for capacitors. The present inventors however, recognized that capacitor packaging designs have been lagging where improving the ESR of the capacitor by other means can yield significantly better results than can improvements in the dielectrics and conductors of the capacitor.

The interconnections 50, although terminating on the same side of the package, are accomplished by soldering a conductive strap 54 on the opposite side of the termination and wrapping the conductive strap 54 around the capacitor package to form interconnections 50 on the same side of the capacitor package. This technique makes the capacitor appear to have the terminations on the same side; but electrically, the connection 51 is brought around to form an interconnecting loop 56 that undesirably adds unwanted inductance and resistance to the overall capacitor to system interconnection.

FIG. 6 is a side view of the cylindrical capacitor shown in FIG. 5, illustrating the current paths in the capacitor plates for the cylindrical capacitor. Since each capacitor electrode metallization is continuous, eddy currents can build in the capacitor due to magnetic flux induced by the capacitor's internal current, producing self heating affects and increasing the overall ESR. The continuous path of the current through the capacitor structure manifests as a self-inductance.

Although external loops have been placed in proximity to the capacitor to produce a magnetic field that opposes the capacitor's internal self inductance magnetic field, such external loops have had only limited success due to the poor coupling between the external loop 56 and the capacitor's ESL that limits its effectiveness.

FIG. 7 illustrates a cylindrical capacitor sectionalized patterned interconnection technology 60 according to one aspect of the invention. Having the interconnections on the same side of the capacitor is important to obtaining very low interconnecting inductance, as stated herein before. The metallization patterning described above with reference to FIGS. 1-4 enables the capacitor 30 to have the terminations on the same side, such as depicted in FIG. 7; and it also offers a capacitor with superior electrical performance having less self-heating and a wider frequency response.

A form factor according to one aspect such as described above for the capacitor 30 is a short and flat cylinder or body height 32 with a wide diameter or body dimension 34, much like a pancake or a short stack of pancakes. This increases the contact area of each interconnection 14 and reduces the current density of the plates by making the patterned plates wider with short lengths along the current carrying path, as stated above. This form factor advantageously takes advantage of the low current density and increased contact area to further reduce the capacitor ESR and ESL, providing a 2 to 3 times benefit for ESL, since ESL is reduced by a shorter and wider current path.

The foregoing form factor decreases the length of a conductor through which current has to flow, and widens the metallization at the end of the capacitor increasing contact area of the interconnections 60. Further, the capacitor structure(s) depicted in FIGS. 1-4 and 7-8 ensures that current flow on each electrode will be opposite and parallel such as depicted in FIG. 8, instead of along the cylinder in one direction such as depicted in FIG. 6. This structure creates magnetic flux cancellation further reducing inductance within the capacitor, as stated above, since the ESL is reduced by the magnetic field cancellation.

The patterned metallization in a cylindrical capacitor is mathematically calculated so that when the metalized film is stacked and then rolled, the interconnecting features 14 of the sectionalized electrodes are made available on the correct side of the circular end of the capacitor 30 to form the half circle connection. In the case of a cookie cut and stacked film capacitor, the connecting feature of the sectionalized electrodes are made available on the one side of the connecting face as edges that can be metalized or as tabs that can be folded and then metalized, thus increasing contact area.

Further, since the cylindrical capacitor sectionalized patterned interconnection technology 60 depicted in FIG. 7 includes its electrical terminations on the same axial side of the cylindrical capacitor, the resultant interconnecting loop 62 exhibits significantly less inductance to the overall capacitor to system interconnection as compared to the state of the art.

FIG. 8 illustrates the current paths in the capacitor plates for the cylindrical capacitor shown in FIG. 7. This structure, as stated above, creates magnetic flux cancellation further reducing inductance within the capacitor.

In summary explanation, an ultra low inductance metalized film capacitor comprises metallization that is sectionalized and patterned to provide interconnections on only one axial side of a rolled or one edge of a stacked film capacitor. This structure provides superior electrical performance over traditional capacitor structures including without limitation, better filtering characteristics, higher current ripple capabilities, lower self-heating, and an increased usable frequency range. This structure further allows a reduction in size, weight and volume of many new products entering the marketplace by eliminating the need for smaller, higher frequency capacitors in a system.

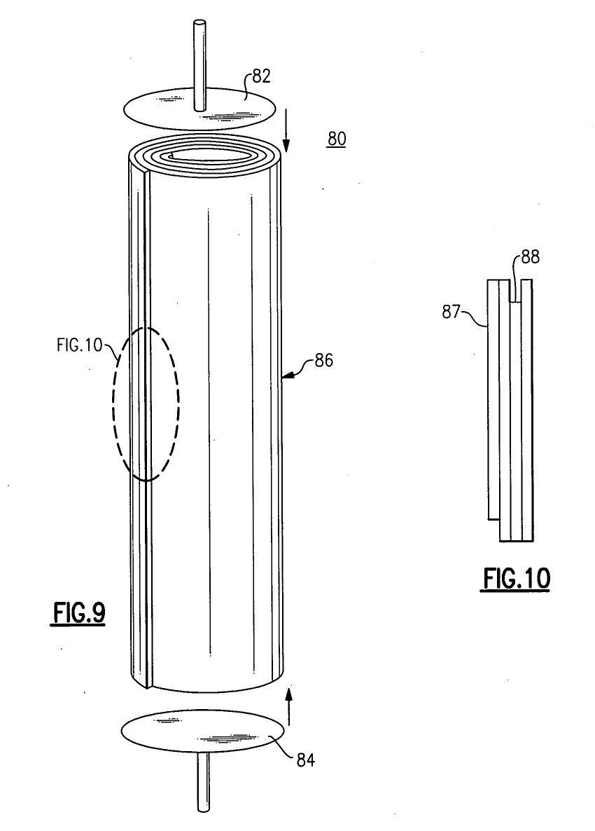

FIGS. 9 and 10 present a more detailed pictorial illustrating a wound film capacitor 80 known in the art and that includes its electrical terminations 82, 84 on both ends of the rolled capacitor cylinder 86. Because the electrical terminations 82 and 84 are disposed on opposite ends of the wound film capacitor 80, current flows along the cylinder 86 in one direction such as depicted in FIG. 6.

FIG. 10 illustrates a cross sectional view of the capacitor plates 87, 88 for the capacitor 80 depicted in FIG. 9.

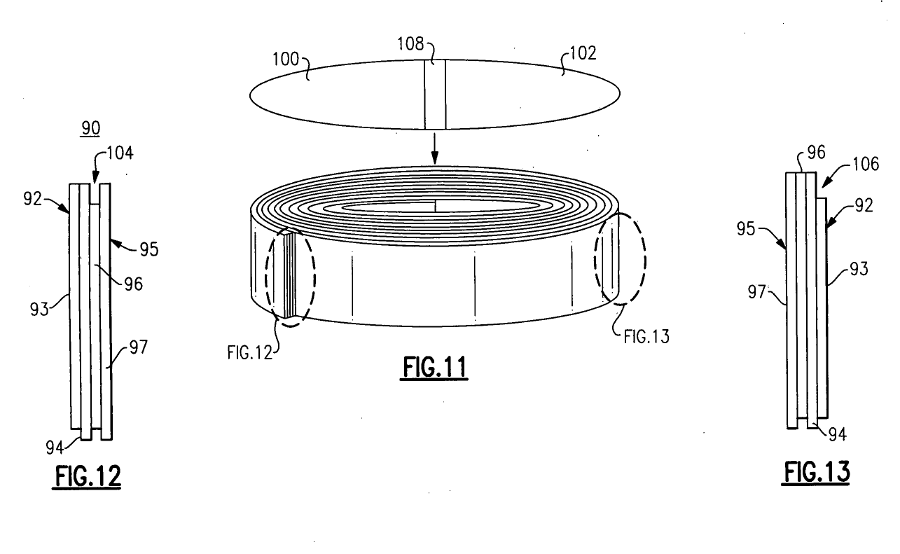

FIGS. 11-13 present a more detailed pictorial diagram illustrating a wound film capacitor structure 90 according to another aspect of the invention. Wound film capacitor structure 90 can be seen to include a first electrode group 92 having a first plate 93 and a first dielectric film layer 94; and a second electrode group 95 having a second plate 96 and a second dielectric film layer 97, suitable for rolling together to form the cylindrical capacitor 90.

The first electrode group 92 is configured with an electrical termination 100 disposed on a first portion of the upper face of the cylindrical capacitor 90 such that the electrical termination 100 makes electrical contact with the first plate 93 of the first electrode group 92. The second electrode group 95 is configured with an electrical termination 102 disposed on a second portion of the upper face of the cylindrical capacitor 90 such that the electrical termination 102 makes electrical contact with the second plate 96 of the second electrode group 95.

Recessed areas 104, 106 associated with the second plate 96 of the second electrode group 95 and the first plate 93 of the first electrode group 92 are together configured such that when the first and second electrode groups 92, 95 are rolled together to implement the cylindrical capacitor structure 90, the recessed areas 104, 106 will align themselves to physically isolate the electrical terminations 100, 102 from one another, thus creating the desired isolation area 108 between the first plate 93 and the second plate 96 of the wound film capacitor structure 90.

FIG. 14 shows a pair of cookie-cut electrodes 110, 112 suitable to form a stacked metalized film capacitor. Electrode 110 is configured with a first capacitor plate 114, while electrode 112 is configured with a second capacitor plate 116.

FIG. 15 shows a stacked capacitor structure 120 implemented using a plurality of cookie-cut electrodes 110, 112 depicted in FIG. 14. Electrodes 110, 112 are configured to be accessible on a common face of the structure 120 such that the plurality of capacitor plates 114 are isolated from the plurality of capacitor plates 116 on the common face.

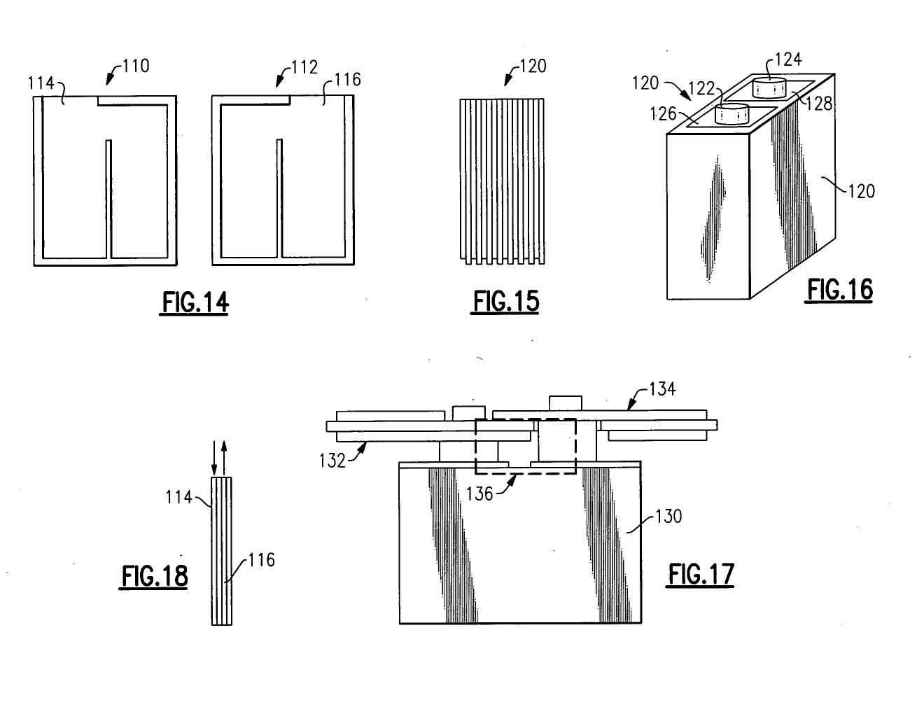

FIG. 16 shows the stacked capacitor structure 120 depicted in FIG. 15 with connecting studs 122, 124 to form a completed stacked capacitor 130. The plurality of capacitor plates 114 are connected together via a corresponding metalized connection 126, while the plurality of capacitor plates 116 are connected together via a corresponding metalized connection 128.

FIG. 17 shows the completed stacked capacitor 130 shown in FIG. 16 connected to DC bus bars with laminar interconnecting structures 132, 134. The resultant structure advantageously provides an interconnecting loop 136 that is smaller than that achievable with known more conventional capacitor packages. The resulting smaller interconnecting loop 136 yields a structure having less inductance to provide advantages discussed above.

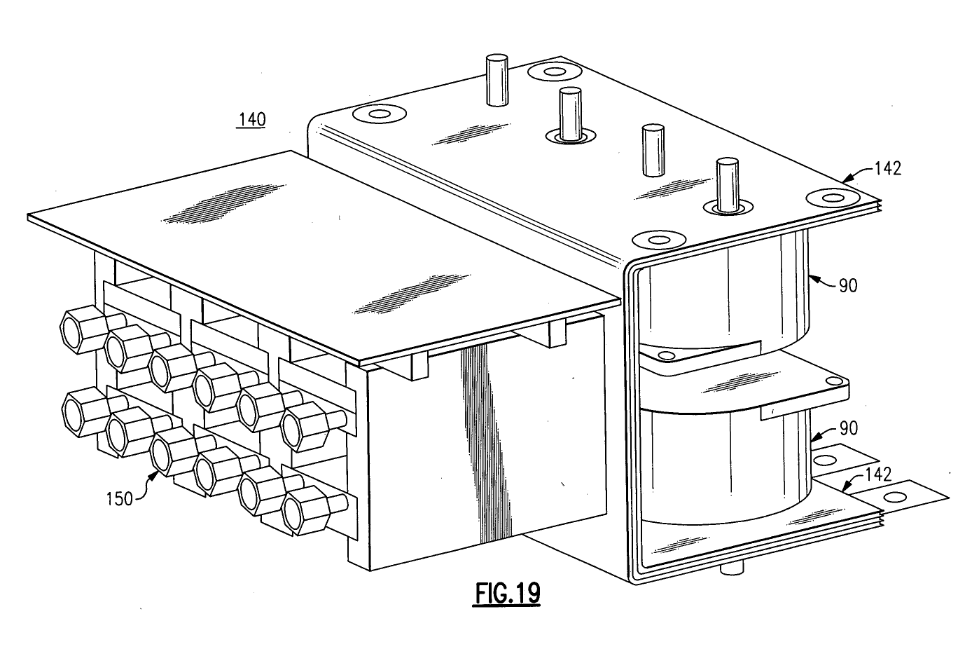

FIG. 18 is a side view of the completed stacked capacitor 130 shown in FIGS. 16-17 illustrating the current flow paths in the plates 114, 116 of the completed stacked capacitor 130 to create magnetic field flux cancelling effects similar to those discussed herein before with reference to circular capacitor structures implemented using the same sectioning and patterning principles.

FIG. 19 illustrates a plurality of high temperature, high performance cylindrical capacitors 90 configured for use within a high density, high power inverter 140 suitable for high end power conversion applications such as, without limitation, avionics applications, according to one aspect of the invention. The capacitors 90 are integrated with the inverter 140 to provide ultra-low inductance interconnections 142. Cylindrical capacitors 90 can just as easily be replaced with stacked capacitors 130 having a rectangular form factor to maximize the capacitance per unit volume of the inverter 140. Fluid cooled power modules 150 are employed to provide internal cooling of the power inverter 140, according to one aspect of the invention.

The cylindrical film capacitors 90 or stacked film capacitors 130 are also well suited for use in high performance EMI filters that require filter performance not otherwise achievable using conventional film capacitors, since capacitors 90 and 130 have a very high self-resonant frequency due to the structures described herein above.

Although particular embodiments have been described with reference to both cylindrical and stacked layer film capacitors, such concepts are believed to also apply under certain conditions to electrolytic and liquid filled type capacitors. Further, the concepts and principles described herein are readily applicable to any type of capacitor having layers of dielectric material and metal electrodes.

The principles described herein are particularly useful in the design and application of high temperature capacitors to power electronics requiring very aggressive high temperature applications including without limitation, avionics, electric vehicles, certain medical applications, wind and oil and gas applications. Capacitors implemented using the principles described herein can, for example, be employed in inverters as DC link capacitors, input, output and, EMI filter capacitors, and in a multitude of other applications relating to electrical energy conversion electronic equipment.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A film capacitor comprising metallization that is sectionalized, patterned and configured to provide interconnections on only one axial side/edge of a rolled or stacked film capacitor.

2. The film capacitor according to claim 1, wherein each metalized section is configured to cancel magnetic fields created by current flow within the capacitor.

3. The film capacitor according to claim 1, wherein each metalized section is configured with a number of sub-partitions based on the size of the corresponding metalized section.

4. The film capacitor according to claim 1, wherein each interconnection is configured substantially as a half circle when the film capacitor is configured as a rolled capacitor.

5. The film capacitor according to claim 1, further comprising at least one terminal connector attached to each interconnection, wherein the at least one terminal connector is selected from metal tabs configured with mounting holes, and male or female studs configured with threaded holes.

6. The film capacitor according to claim 1, wherein the metallization comprises a first electrode group and a second electrode group that are together configured such that as the film is stacked or rolled, the resultant metallization pattern creates two distinct interconnections, one for each electrode of the capacitor on a half side of the capacitor designated for that connection.

7. The film capacitor according to claim 1, wherein the sectionalized and patterned metallization is configured to substantially minimize eddy currents produced by directional current flow on the patterned capacitor plates.

8. The film capacitor according to claim 1, wherein the sectionalized and patterned metallization is configured to substantially minimize capacitor current density and equivalent series resistance below that achievable with conventional film capacitors.

9. The film capacitor according to claim 1, wherein the sectionalized and patterned metallization is configured to ensure current flow on each electrode will be opposite and parallel to one another to create magnetic flux cancellation affects within the capacitor.

10. The film capacitor according to claim 1, wherein the sectionalized and patterned metallization is configured such that as the metalized film is rolled or stacked, the interconnecting features of the sectionalized electrodes are disposed on only one substantially planar face of a circular end of a rolled capacitor or on only one substantially planar face of a stacked capacitor.

11. The film capacitor according to claim 1, wherein the sectionalized and patterned metallization is further configured to provide an ultra-low inductance interconnection between the film capacitor and a high power inverter such that the ultra-low inductance is lower than that achievable with a conventional film capacitor having interconnections on more than one face of the capacitor.

12. The film capacitor according to claim 1, wherein the sectionalized and patterned metallization is further configured such that as the film is stacked or rolled, the resultant stacked or rolled film capacitor has a low profile, large diameter pancake configuration to reduce its equivalent series inductance below that achievable with conventional film capacitors.

13. The film capacitor according to claim 1, wherein the sectionalized and patterned metallization is further configured such that as the film is stacked or rolled, the resultant stacked or rolled film capacitor has a very high self-resonant frequency suitable for use in high performance EMI filters that require filter performance not achievable using conventional film capacitors.

14. The film capacitor according to claim 1, wherein the interconnections comprise a plurality of spray attached metalized conductors.

15. The film capacitor according to claim 1, further comprising:
a low viscosity filler material configured to at least partially fill in recessed areas of the rolled or stacked film capacitor, and further configured to substantially prevent shorting conditions associated with the film capacitor; and
at least one metalized contact area sprayed on at least one portion of the filled areas to form the interconnections.

16. A method of making a film capacitor, the method comprising:
patterning a first metalized film electrode group and a second metalized film electrode group to form a common dielectric structure; and
rolling the common dielectric structure such that the first metalized film electrode group and the second metalized film electrode group together form a sectioned and patterned metalized film capacitor having interconnections on only one edge of a circular end of the capacitor.

17. The method of claim 16, wherein patterning a first metalized film electrode group comprises:
applying a first mask to a first film element;
applying a metal layer to the first film element; and
removing the first mask to provide a first sectionalized and patterned metalized film on the first film element.

18. The method of claim 17, wherein applying a first mask to a first film element comprises applying a one-time use protective coating material to desired portions of the first film element.

19. The method of claim 17, wherein applying a first mask to a first film element comprises covering desired portions of the first film element with a reusable film element protective cover.

20. The method of claim 17, wherein patterning a second metalized film electrode group comprises:
applying a second mask to a second film element;
applying a metal layer to the second film element; and
removing the second mask to provide a second sectionalized and patterned metalized film on the second film element.

21. The method of claim 20, wherein applying a second mask to a second film element comprises applying a one-time use protective coating material to desired portions of the second film element.

22. The method of claim 20, wherein applying a second mask to a second film element comprises covering desired portions of the second film element with a reusable film element protective cover.

23. A method of making a film capacitor, the method comprising:
patterning a first metalized film electrode group and a second metalized electrode group to form a common dielectric structure;
rolling the common dielectric structure such that together the first metalized film electrode group and the second metalized film electrode group form a roll of sectioned and patterned metalized film;
slicing a desired number of sections from the roll of sectioned and patterned metalized film; and
stacking the desired number of sections together to form a stacked metalized film capacitor having interconnections on only one edge of the stacked film capacitor.

24. The method of claim 23, wherein patterning a first metalized film electrode group comprises:
applying a first mask to a first film element;
applying a metal layer to the first film element; and
removing the first mask to provide a first sectionalized and patterned metalized film on the first film element.

25. The method of claim 24, wherein patterning a second metalized film electrode group comprises:
applying a second mask to a second film element;
applying a metal layer to the second film element; and
removing the second mask to provide a second sectionalized and patterned metalized film on the second film element.

26. A method of making a film capacitor, the method comprising:
patterning at least one first metalized film electrode;
patterning at least one second metalized film electrode; and
stacking the at least one first metalized film electrode and the at least one second metalized film electrode such that together the at least one first metalized film electrode and the at least one second metalized film electrode form a stacked metalized film capacitor having interconnections on only one face of the stacked film capacitor.

27. The method of claim 26, wherein patterning at least one first metalized film electrode comprises:
applying a first mask to a first film element;
applying a metal layer to the first film element; and
removing the first mask to provide a first sectionalized and patterned metalized film on the first film element.

28. The method of claim 27, wherein patterning at least one second metalized film electrode comprises:
applying a second mask to a second film element;
applying a metal layer to the second film element; and
removing the second mask to provide a second sectionalized and patterned metalized film on the second film element.

29. The method of claim 26, further comprising stacking the at least one first metalized film electrode and the at least one second metalized film electrode to provide a stacked or rolled film capacitor having a low profile, large diameter pancake configuration to reduce its equivalent series inductance below that achievable with conventional film capacitors.

30. The method of claim 26, further comprising stacking the at least one first metalized film electrode and the at least one second metalized film electrode to provide a stacked or rolled film capacitor having a very high self-resonant frequency suitable for use in high performance EMI filters that require filter performance not otherwise achievable using conventional film capacitors.

31. The method of claim 26, further comprising spray attaching a plurality of terminal conductors to the rolled or stacked film capacitor.

32. The method of claim 26, further comprising:
filling in recessed areas of the rolled or stacked film capacitor at least partially with a low viscosity filler material; and
spraying at least one portion of the filled areas to provide at least one metalized contact area.
